(19) United States
(12) Patent Application Publication
(10) Pub. No.: US 2007/0202985 A1
(43) Pub. Date: Aug. 30, 2007

(54) Satellite Gearing

(75) Inventor: Herwig Fischer, Willich (DE)

Correspondence Address: K.F. ROSS P.C., 5683 RIVERDALE AVENUE, SUITE 203 BOX 900, BRONX, NY, 10471-0900, US

(73) Assignee: SATELLITE GEAR SYSTEMS B.V., NL-1012 KK AMSTERDAM (NL)

(21) Appl. No.: 10/587,813

(22) PCT Filed: Jan. 28, 2005
(86) PCT No.: PCT/EP05/00852

§ 371 Date: Apr. 25, 2007

(30) Foreign Application Priority Data
Jan. 30, 2004 (DE) 10 2004 004 849.5

(51) Int. Cl. F16H 31/00

(52) U.S. Cl. 475/331

(57) ABSTRACT

The invention relates to a continuous, circulating switch mechanism gearing (satellite gearing) provided with integrated freewheels, whereby the satellites (13) are guided on radial segments (15) in two sections and are maintained counter to the centrifugal force. Pins (18) of a rotor (17) transmitting the torque are guided through slits in the radial segments. In a preferred variant, each gear step is divided into two axially offset halves wherein the toothing (11) is connected to the annular disk (10) in a torsionally elastic manner (12).

The invention relates to a planetary-gear transmission configured as a rotating shift transmission with integrated freewheels, comprising input and output elements that as a result of displacement in a plurality of concentric or eccentric positions create varying gear ratios and of which one is configured as a ring gear with at least one tooth ring and the other is configured as a rotor, wherein rotating planetary gears with tooth profiles can be coupled positively with the tooth ring and in the coupled state transmit torque from the input element to the output element.

Planetary-gear transmissions of the kind described above are disclosed for example in EP 0 708 896 B1. The planetary-gear transmission revealed there comprises several individual gears that together form a planetary gear connected to a central gear in a permanent positive-mesh connection. The ratios of the effective radii of the planet gear and the central gear and the mutual eccentric positions of the planet gear and the central gear, which positions can be varied by suitable means, determine the speed ratios between the input and output elements. The gears forming the planet gear, when disposed eccentrically to the central gear, cyclically cross a torque-transmitting load path and a load-free path. The gears are rotatable both about the planet gear axis and via one-way clutches about their own axes, so that during the transition from the load-free path to the arcuate load path they are able to transmit the present torque while blocking their own rotations as a result of positive engagement. According to EP 0 708 896 B1, fluctuations in the transmission of torque are supposed to be compensated at least partially through cyclical control by varying the effective radii defining the load path and/or the effective tangential components.

A planetary-gear transmission is also disclosed in WO 03/060348 A1, in which a ring gear with an annular groove on one hand and a star wheel with radial grooves on the other hand form the input and output elements. Satellites, which can be coupled to the ring gear, transmit torque to the star wheel by means of coupling pins. In order to reduce or eliminate irregularities by varying the effective radii defined by the load path, each satellite comprises a radial groove in which the coupling pin can be guided inside the load path at least substantially relative to a center of the ring gear.

The planetary-gear transmissions mentioned above can have a compact design and be used for the continuous variation of the rotational speeds of ancillary units, for example in motor vehicle construction.

With a compact design, however, an unfavorable material stress distribution may develop in critical components, resulting in less than optimal material utilization. Particularly the planetary-gear transmission disclosed in WO 03/060348 A1 with the single-level power transmission between the ring gear with the gearing, the satellites, the coupling pins and the star wheel is the reason that both the contact pressure distribution in the contact areas between these components and the bending stress occurring inside the components reach very high peak values that are responsible for the dimensions, however only low average values are reached, which produce the permissible load limit for the gear transmission.

Furthermore, the centrifugal forces of the planetary gears and the coupling pins occurring in the overrunning mode, which additionally are absorbed in a single-level manner by the addressed edge loads, apply stress on the idle drag resistance and consequently the efficiency of the transmission.

It is the object of the present invention to provide a planetary-gear transmission in which high material stress in the components is avoided, centrifugal forces are absorbed and running resistance is reduced.

This object is achieved with the satellite gear transmission according to claim 1, in which each planetary gear is connected to the rotor by means of a radial segment that is mounted rotatably about an axis of rotation it has in common with the rotor. The primary effects of the radial segment are the absorption of the centrifugal forces and the provision of new design possibilities that prevent high material stress levels.

Further developments of the invention are disclosed in the dependent claims.

The radial segments are tapered in the axial direction in the area of the axis of rotation and disposed in an offset manner in relation to the respectively adjacent radial segments. The radial segments preferably mesh with each other in the area of the axis of rotation. The radial segments can be configured in a multi-level, preferably a double-level manner both on the axis of rotation and on the opposite end. In particular, according to a special embodiment of the invention, the radial segments may comprise two bores, through which a coupling pin carrying the planetary gear is pushed, on the end facing away from the axis of rotation or in a two-level configuration.

The connection between the radial segments and the output element is ensured in that the radial segments are provided with slots through which the pins of the rotor pass. The slots of the radial segments are preferably configured asymmetrically such that a wider bending carrier is created in the direction of torque transmission, and a flatter bending carrier in the idle direction.

According to another embodiment of the invention, the pins can rotate freely on flanges of the rotor, or the contact area of the pins to the radial segments is configured in a rotationally free manner, preferably by means of a multi-part configuration, wherein particularly the pins are flattened, thus producing a surface contact, particularly a surface contact across the entire surface between the radial segments and the pins.

According to another embodiment of the invention, the ring gear guides the tooth ring in a torsionally flexible, radial and plane parallel manner, preferably by interposing a rubber ring (as a spring system).

In a practical embodiment, a gear stage may comprise two or more parts that are disposed mutually axially offset, with adjoining planetary gears being part of different parts and preferably comprising a separate spring system.

Further advantages and embodiments are explained hereinafter with reference to the drawings. Therein:

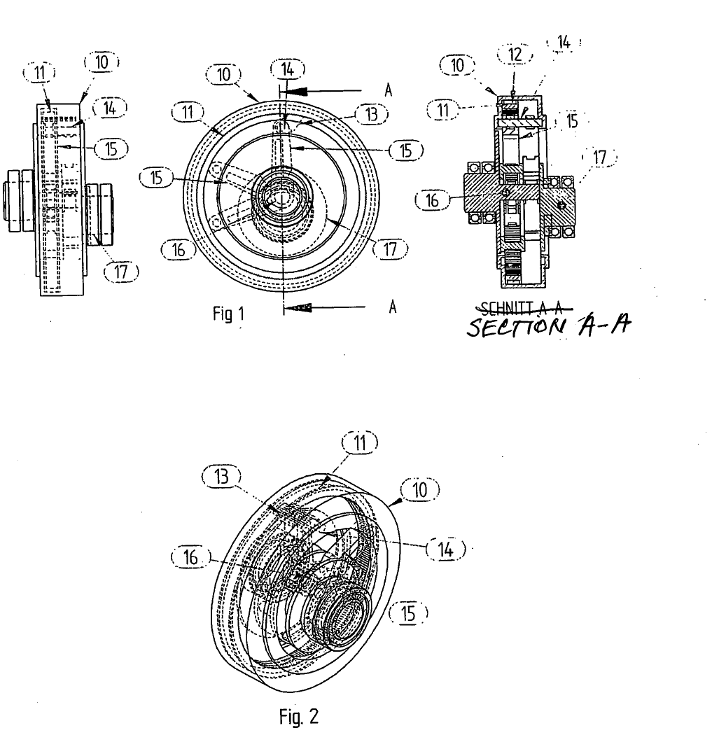

FIG. 1 shows a gear stage in three side views;

FIG. 2 shows the gear stage in a perspective view;

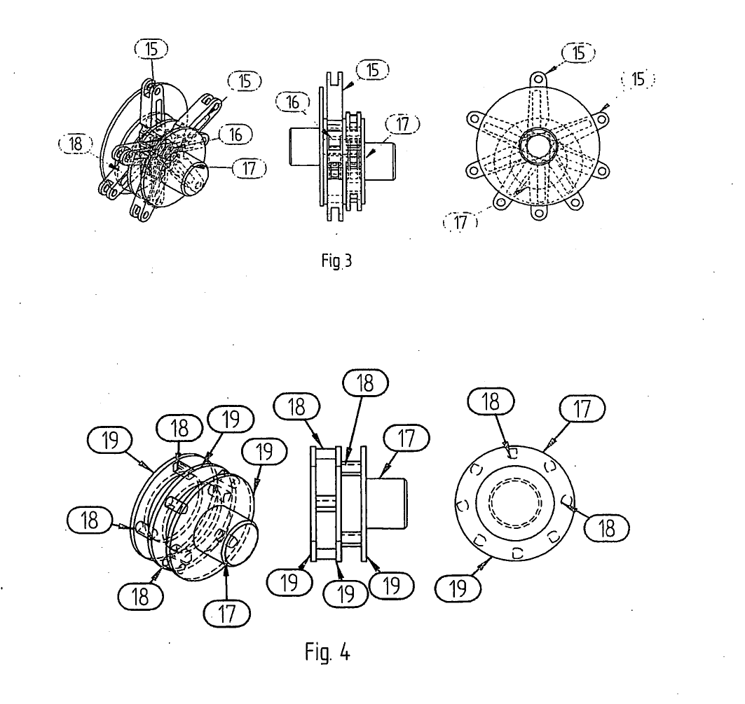

FIG. 3 shows in perspective view as well as two views laterally of the axis the radial segments and the rotor from FIG. 1; and

FIG. 4 shows the rotor in three different views.

In particular FIGS. 1 and 2 illustrate a gear stage (without housing) comprising a ring gear 10, in which stage toothed disks 11 are guided radially and parallel in two axially offset planes and transmit torque in a torsionally flexible manner via rubber rings 12. Planetary gears 13 are connected via coupling pins 14 to radial segments 15 that rotate about the axle 16 axially offset from one another. A rotor 17 comprising flanges 19 and pins 18 that are guided through radial grooves of the segments 15 can be set eccentric positions by means of a device, which is not illustrated, allowing the continuous variation of a plurality of gear ratios.

Unlike in the state of the art, the planetary gears are therefore no longer coupled to the star wheel directly via coupling pins. Rather, the planetary gears 13 are guided on the radial segments 15 that rotate along with the planetary gears 13 that absorb centrifugal forces at minimal sliding speeds because they are guided on the (rotation) axle 16. In order to fit on this axle 16, the segments 15 are axially offset from and nested in each other. Force transmission to the output is effected by the rotor 17 with the pins 18 that run in slots of the radial segments 15 and the rotational movements of which are converted via flanges 19 of the rotor. The transmission ratio is set continuously as a result of the eccentric offset of the rotor 17 relative to the axle 16 of the ring gear 10 and the radial segments 15.

The planetary gears 13 are guided in a two-level configuration in the radial segments 15 with the pins 14 and are able to rotate in the pins 14 for engagement and disengagement. The centrifugal forces are not absorbed at high sliding speeds, as is the case in the configuration disclosed in WO 03/060348 A1, but in the bearings of the segments 15 on the axle 16, resulting in little loss. The torque-transmitting peripheral forces are transmitted everywhere in a two-level manner both on the axle 16 and also in the area of the pins so that in the gearing and in the rotor no asymmetrical edge load develops, but instead a contact pressure that is substantially constant across the contact surface. The material stress in the pins 14 is reduced substantially to mere shear since bending stress disappears almost completely and/or is negligibly small.

The eccentric displacement required for setting the desired gear ratio is small. Additionally, now the component with the smallest diameter, namely the rotor, and no longer the star wheel with the largest diameter (as is the case with the planetary-gear transmission according to WO 03/060348 A1), is displaced, creating a significantly smaller housing size.

As a result of the geometry, the overrunning speeds in the gearing required for a defined gear ratio are significantly smaller, producing a correspondingly positive effect on the noise, wear and drag resistance that are produced.

In order to compensate for fluctuations, the gear stage is preferably subdivided into two planes, with the tooth rings 11 in the ring gear 10 being guided radially and plane parallel via peripheral grooves, however initially rotating freely in these grooves. The rubber ring 12, which is connected both to the ring gear 10 and the tooth ring 11 in a positive-mesh and/or flush fit, acts as a torsionally flexible coupling. The planetary gears 13 run offset in the two planes, so that the torsional flexibility uncouples the engaged planetary gear from the subsequent planetary gear that will engage next. This way an overlap of the load cycles of adjoining planetary gears is achieved, additionally softening the tangential jumps of the transmission functions in the coupling point. As shown in FIG. 3, for example 2 x 4 planetary gears 15 can rotate in adjoining planes, which allows a minimal installation width to be achieved because the radial segments 15 are configured in a two-level manner on the axle 16 and are nested in each other.

The core idea of the present invention can be summarized as follows: Initially, the planetary gears 13 are connected to radial segments, as a result of which centrifugal forces are absorbed in overrunning mode. Furthermore, the radial segments are offset in the area of the axle 16 to a smaller axial dimension, preferably reduced in terms of width in a two-level manner, and mutually offset axially such that several radial segments are able to rotate jointly on one axle. The radial segments 15 comprise slots, through which the pins 18 of the rotor 17 are guided, conveying the torque via this rotor 17. The slots of the radial segments are preferably configured asymmetrically such that a wider bending support is created in the direction of torque transmission, and a flatter bending support in the idle direction.

The satellites are preferably guided in a multi-level, at least double-level manner in the radial segments. The radial segments are preferably also guided on the axle in a multi-level, at least double-level manner.

The pins 18 can rotate freely on the flanges 19 and/or the contact area of the pins 18 and the radial segments 15 due to the multi-part configuration is configured in a rotationally free design, so that the pins in this area can be flattened. Between the radial segments 15 and the pins 18, surface contact extending across the entire surface is possible (instead of the Hertz model of linear contact).

Furthermore, the ring gear 10 and the toothed gears 11 are guided in a torsionally flexible, radial and plane parallel manner. By dividing a gear stage into two or more parts that are disposed axially offset, with adjoining planetary gears being part of different parts, a separate spring system can be achieved for adjoining planetary gears.

1. A planetary-gear transmission configured as a rotating shift transmission with integrated freewheels, comprising input and output elements that as a result of displacement in a plurality of concentric or eccentric positions create varying gear ratios and of which one is configured as a ring gear (10) with at least one tooth ring (11) and the other is configured as a rotor (17), rotating planetary gears (13) with tooth profiles being coupled positively to a tooth ring (11) and in the coupled state torque being transmitted from the input element to the output element, characterized in that each planetary gear (13) is connected to the rotor (17) via a radial segment (15) that is disposed rotatably about an axle (16) it has in common with the rotor.

2. The planetary-gear transmission according to claim 1, characterized in that the radial segments (15) are tapered in the axial direction in the area of the axle (16) and offset from the respectively adjoining radial segments (15), the radial segments (15) preferably mutually meshing, preferably in the area of the axle (16).

3. The planetary-gear transmission according to claim 1, characterized in that the radial segments (15) are configured in a multi-level, preferably double-level manner on the axle (16) and/or the other end.

4. The planetary-gear transmission according to claim 1, characterized in that the radial segments (15) comprise two bores, through which a coupling pin carrying the planetary gear (13) is pushed, on the ends facing away from the axle (16) or in a two-level configuration.

5. The planetary-gear transmission according to claim 1, characterized in that the radial segments (15) comprise slots through which the pins (18) of the rotor (17) are guided.

6. The planetary-gear transmission according to claim 5, characterized in that the slots of the radial segments (15) are disposed asymmetrically such that a wider bending carrier is created in the direction of torque transmission and a flatter bending carrier in the idle direction.

7. The planetary-gear transmission according to claim 5, characterized in that the pins (18) can rotate freely on flanges (19) of the rotor (17) or that the contact area of the pins (18) to the radial segments (15) has a free rotatory design, preferably due a multi-part configuration, the pins (18) preferably being flattened, so that a surface contact is created between the radial segments (15) and the pins (18), preferably a surface contact extending across the entire surface.

8. The planetary-gear transmission according to claim 1, characterized in that the ring gear (10) guides the or each tooth ring (11) in a torsionally flexible, radial and plane parallel manner, preferably via a rubber ring (12).

9. The planetary-gear transmission according to claim 1, characterized in that a gear stage may comprise two or more parts that are disposed mutually axially offset, with adjoining planetary gears being part of different parts and preferably comprising separate spring systems.
